(19) United States
(12) Patent Application Publication
(10) Pub. No.: US 2017/0374172 A1
(43) Pub. Date: Dec. 28, 2017

(54) METHOD AND DEVICE FOR PROVIDING SPONSORED COMMUNICATION SERVICES TO LOAN NON-ELIGIBLE SUBSCRIBERS

(71) Applicant: Comviva Technologies Ltd., Haryana (IN)

(72) Inventors: Manish Kumar JAIN, Delhi (IN); Arun RABRA, Haryana (IN)

(21) Appl. No.: 15/546,210

(22) PCT Filed: Dec. 23, 2015
(86) PCT No.: PCT/IB2015/059928

§ 371 Date: Jul. 25, 2017

(30) Foreign Application Priority Data
Dec. 31, 2014 (IN) 4023/DEL/2014

(51) Int. Cl. H04L 29/08; G06Q 40/02; H04M 15/00

(52) U.S. Cl. CPC H04L 67/2804; H04M 15/854; G06Q 40/025; H04M 2215/0192

(57) ABSTRACT

The present invention provides a method for providing sponsored communication services in a telecommunication network to loan non-eligible subscribers comprising: receiving, by a proxy device, a communication request originating from an initiating party and forwarding the communication request to a loan granting system; receiving, by the proxy device, a signal indicative of loan refusal (because the subscriber is a loan non-eligible subscriber) from the loan granting system; informing the initiating party, by the proxy device, terms of sponsorship and seeking approval from the initiating party; receiving, by the proxy device, a signal indicative of approval by the initiating party; and sending, by the proxy device, routing information to a routing device for storing in respect of the initiating party, the routing device acting upon the routing information while providing a communication service.

### FIELD OF THE INVENTION

The present invention relates to method and device for providing supporting communication service in a telecommunication network. Particularly, the invention relates to providing sponsored communication services in a telecommunication network to loan non-eligible subscribers.

### BACKGROUND OF THE INVENTION

A subscriber can avail services in a telecommunication network either by becoming a pre-paid customer or by becoming a post-paid customer. In a pre-paid scenario, certain amount of communication services is purchased in advance, and when the purchased communication services have been used, the customer is required to replenish the same. Thus, in case of the pre-paid customers, a balance amount acts as a threshold value for which services can be consumed by the customer. On the other hand, in case of post-paid scenario, the customer enters into, for example, a monthly payment schedule and payment is usually provided after the services are used. In case of the post-paid scenario, the telecommunication network operator can set up threshold associated with amount of consumption that can be done by the customer. In both of the aforesaid cases, once the threshold is crossed, the ability of the subscriber to effectively consume the communication services can be interrupted.

There can be instances where the telecommunication network operator may have means for providing loan for certain amount to subscribers. It has been observed that the same tends to increase the revenue generated for the telecommunication network operator. However, not all telecommunication networks have the necessary network configuration (i.e. required hardware and software) for providing the loan. Even in respect of the telecommunication networks that have the necessary network configuration, it is not essential that loan will be provided to every subscriber.

Thus in a telecommunication network there can exist certain amount of subscriber who are loan non-eligible subscribers. If communication services can be provided to such loan non-eligible subscribers in an effective manner, the revenue for the telecommunication network operator can be increased without taking substantial risk.

Thus, there exists a need to develop method and system for providing communication services to such loan non-eligible subscribers.

### SUMMARY OF THE INVENTION

To cater to the above requirement, there is provided a method for supporting communication service, said method comprising:

receiving, by a proxy device, a communication request originating from an initiating party and forwarding the communication request to a loan granting system;

receiving, by the proxy device, a signal indicative of loan refusal (because the subscriber is a loan non-eligible subscriber) from the loan granting system;

informing the initiating party, by the proxy device, terms of sponsorship and seeking approval from the initiating party;

receiving, by the proxy device, a signal indicative of approval by the initiating party; and

sending, by the proxy device, routing information to a routing device for storing in respect of the initiating party, the routing device acting upon the routing information while providing a communication service.

Additionally, there is provided a device for supporting communication service, said device comprising:

a first receiving module for receiving a communication request originating from an initiating party;

a first transmitting module for forwarding the communication request to a loan granting system;

a second receiving module for receiving a signal indicative of loan refusal from the loan granting system;

a message generation module for informing the initiating party terms of sponsorship and seeking approval from the initiating party;

the first receiving module being further adapted to receiving a signal indicative of approval by the user; and

a routing information generation module for generating and sending routing information to a routing device for storing in respect of the user, the routing device acting upon the routing information while providing the communication service.

To further clarify advantages and features of the present invention, a more particular description of the invention will be rendered by reference to specific embodiments thereof, which is illustrated in the appended figures. It is appreciated that these figures depict only typical embodiments of the invention and are therefore not to be considered limiting of its scope. The invention will be described and explained with additional specificity and detail with the accompanying figures.

### BRIEF DESCRIPTION OF FIGURES

These and other features, aspects, and advantages of the present invention will become better understood when the following detailed description is read with reference to the accompanying figures in which like characters represent like parts throughout the figures, wherein:

FIG. 1 illustrates flow chart of a method for supporting communication services in accordance with an embodiment of the present invention;

FIG. 2 illustrates block diagram of a device that can implement the method illustrated in FIG. 1 in accordance with an embodiment of the present invention;

FIG. 3 illustrates a call flow chart for enabling supporting of communication services in accordance with a first embodiment of the present invention;

FIG. 4 illustrates a call flow chart for enabling supporting of communication services in accordance with a second embodiment of the present invention;

FIG. 5 illustrates a call flow chart for providing subscriber specific additional information to a loan non-eligible subscriber, when the loan non-eligible subscriber acts as an initiating party in accordance with an embodiment of the present invention;

FIG. 6 illustrates a call flow chart for providing subscriber specific additional information to an initiating party trying to contact a loan non-eligible subscriber as terminating party in accordance with an embodiment of the present invention;

FIG. 7 illustrates a value added service flow chart for providing subscriber specific additional information to a loan non-eligible subscriber, when the loan non-eligible subscriber acts as a receiving party in accordance with an embodiment of the present invention; and

FIG. 8 illustrates a value added service flow chart for providing subscriber specific additional information to an initiating party connected to a loan non-eligible subscriber as terminating party in accordance with an embodiment of the present invention.

Further, skilled artisans will appreciate that elements in the figures are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those of ordinary skill in the art having benefit of the description herein.

### DETAILED DESCRIPTION

For the purpose of promoting an understanding of the principles of the invention, reference will now be made to the embodiment illustrated in the figures and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present invention will be described below in detail with reference to the accompanying figures.

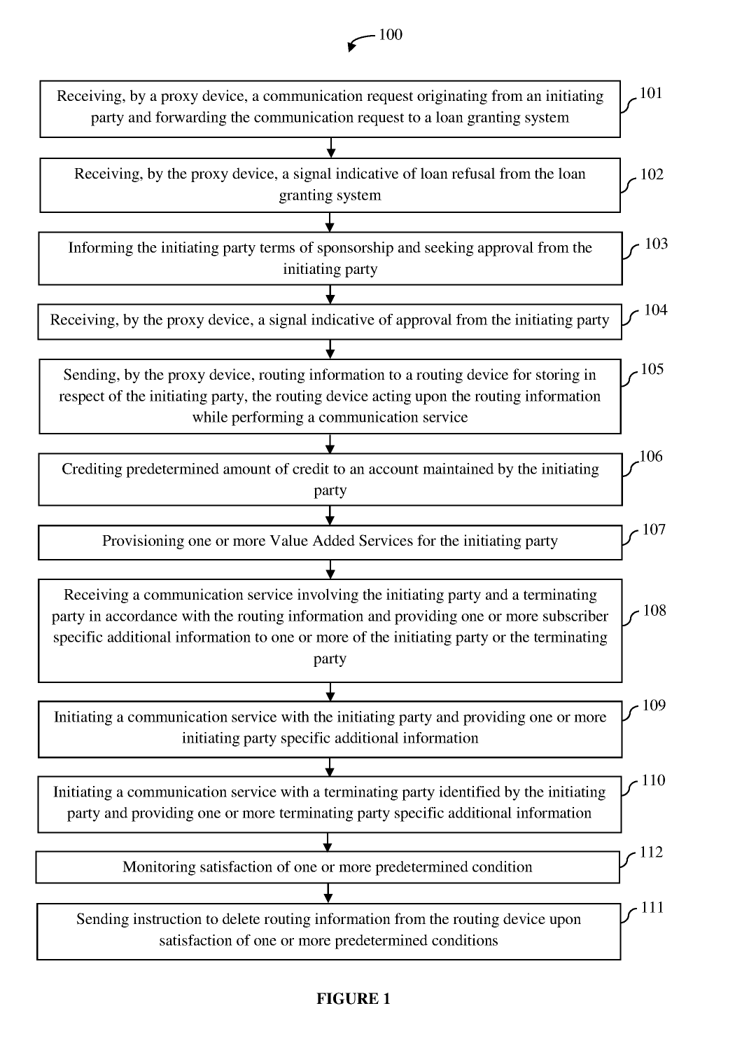

Now referring to FIG. 1, there is illustrated a method (100) for supporting communication service, said method comprising:

receiving (101), by a proxy device, a communication request originating from an initiating party and forwarding the communication request to a loan granting system;

receiving (102), by the proxy device, a signal indicative of loan refusal from the loan granting system;

informing (103) the initiating party, by the proxy device, terms of sponsorship and seeking approval from the initiating party;

receiving (104), by the proxy device, a signal indicative of approval by the initiating party; and

sending (105), by the proxy device, routing information to a routing device for storing in respect of the initiating party, the routing device acting upon the routing information while providing a communication service.

In an embodiment of the present invention, the proxy device receives the communication request in case:
the initiating party has insufficient balance for the requested communication service; or
the communication request originating from the initiating party is preceded by special identifier.

In another embodiment, the method of the present invention further comprises: crediting (106) predetermined amount of credit to an account maintained for the initiating party.

In yet another embodiment, the method of the present invention further comprises: provisioning (107) one or more value added services for the initiating party.

In still another embodiment, the method of the present invention further comprises: receiving (108) a communication service involving the initiating party and a terminating party in accordance with the routing information and providing one or more subscriber specific additional information to one or more of the initiating party or the terminating party.

In a further embodiment of the present invention, providing one or more subscriber specific additional information advertisement comprises intercepting a call and providing a special tone at a predetermined time.

In a furthermore embodiment of the present invention, the special tone is based on the profile of the initiating party or the terminating party.

In an embodiment of the present invention, providing the one or more subscriber specific additional information comprises intercepting a text message and inserting a text based additional information in the text message.

In another embodiment, the method of the present invention further comprises: initiating (109) a communication service to the initiating party and providing one or more initiating party specific additional information to the initiating party.

In yet another embodiment, the method of the present invention further comprises: initiating (110) a communication service with a terminating party as identified by the initiating party and providing one or more terminating party specific additional information to the terminating party.

In still another embodiment, the method of the present invention further comprises: sending (111), by the proxy device, instruction for deletion of the routing information from the routing device upon satisfaction of one or more predetermined conditions.

In another embodiment, the method of the present invention further comprises: monitoring (112) satisfaction of said one or more predetermined conditions.

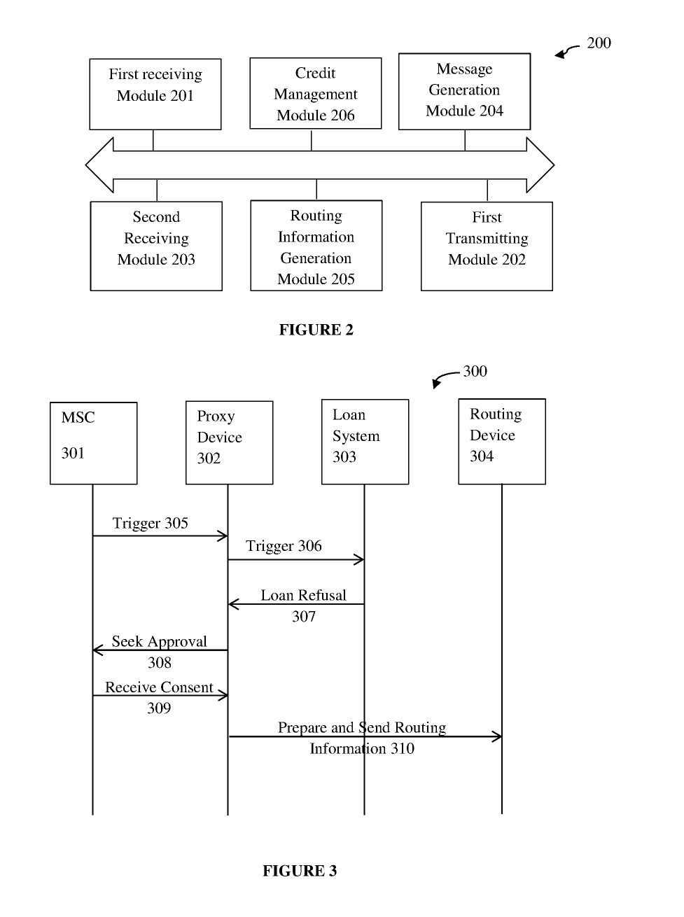

Now referring to FIG. 2, there is illustrated a device (200) for supporting communication service, said device comprising:

a first receiving module (201) for receiving a communication request originating from an initiating party;

a first transmitting module (202) for forwarding the communication request to a loan granting system;

a second receiving module (203) for receiving a signal indicative of loan refusal from the loan granting system;

a message generation module (204) for informing the initiating party terms of sponsorship and seeking approval from the initiating party;

the first receiving module (201) being further adapted to receiving a signal indicative of approval by the user; and

a routing information generation module (205) for generating and sending routing information to a routing device for storing in respect of the user, the routing device acting upon the routing information while providing the communication service.

The device (200) further comprises a credit management module (206) that deposits predetermined amount of credit to an account maintained for the initiating party. Also, the credit management module monitors satisfaction of said one or more predetermined conditions and sends instruction for deletion of the routing information from the routing device upon satisfaction of said one or more predetermined conditions.

In the following paragraphs a detailed description about implementation of the aforesaid method and construction of some of the specific devices is provided. It should however, be understood every implementation of the method need not follow the scenario as mentioned in the following paragraphs. Thus, the scope of the claims is intended to be restricted only on the basis of the claims and their equivalents and not on the basis of the examples provided herein below.

In a telecommunication network that has the necessary network configurations for providing loan it is not essential that loan will be provided to every subscriber. Generally, loan is provided only to needy subscribers (i.e. subscribers having balance are not offered loan). Subscribers who are of defaulters or subscribers who have been blacklisted are generally not offered loan. There can also arise instances wherein loan can be refused to a needy subscriber despite who is neither a defaulter or blacklisted subscriber merely on account of not having relationship with the telecommunication network operator for a sufficient period of time. Thus, the term “loan non-eligible subscriber” is intended to cover a subscriber who has been refused or can be refused the loan for any of the aforesaid reasons or for any other reasons.

In such aforesaid instances, while the network operator or the loan granting system may not provide for loan to the subscriber, there can be provisioned an alternative mechanism for supporting the communication services thus being sought by the loan non-eligible subscriber.

Now referring to FIG. 3, a high level call flow chart (300) for enabling the communication services to be provided to a loan non-eligible subscriber is illustrated. Being a high level call flow chart, the same merely illustrates some of the prominent components which take part in the call flow and therefore, merely represents a mobile switching centre (MSC) (301), which is in operational connection with a proxy device (302). The proxy device is in turn in operational interconnection with a loan granting system (303) and a routing device (304).

The MSC (301) sends (305, 306) a trigger to the loan granting system (303). In one option, as illustrated in FIG. 3, the trigger from the MSC (301) can be routed to the loan granting system (303) via the proxy device (302). In such case, the loan granting system sends its response via the proxy device. In case the loan granting system sends a signal representing loan rejection (307), the proxy device (302) can seek approval for sponsorship from the subscriber (308). In case the proxy device (302) receives consent (309) from the subscriber, the proxy device (302) then prepares routing information as will be applicable to the subscriber and sends (310) the routing information to the routing device (304).

Although not illustrated in FIG. 3, the proxy device further sends credit related information to a network entity, based on which predetermined amount of credit will be deposited to an account maintained for the initiating party.

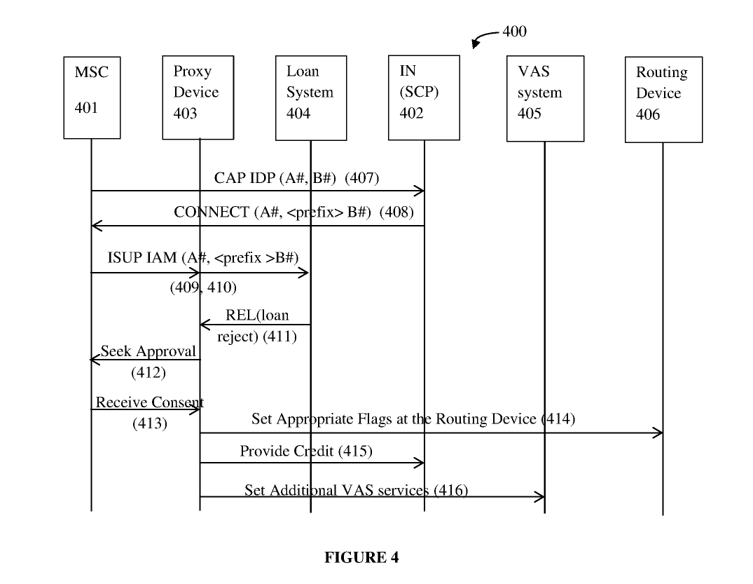

Now referring to FIG. 4, a call flow chart (400) for enabling the communication services to be provided to a loan non-eligible subscriber is illustrated. Compared to FIG. 3, the call flow chart of FIG. 4 is more elaborate and hence the same illustrates major components that take part in the call flow which include, a mobile switching centre (MSC) (401), which is in operational connection with an intelligent network component (IN SCP) (402) that determines whether the subscriber has a valid balance or not. The MSC is also in operational connection with a proxy device (403). The proxy device (403) is also in operational communication with the intelligent network component (IN SCP) (402), a loan granting system (404), a value added service configuration system (405) and a routing device (406).

Coming to the functioning, the MSC (401) sends a query (407) to the intelligent network component (IN SCP) (402) to determine whether the subscriber has a valid balance or not. Assuming that IN SCP is pre-configured to direct the MSC to contact the loan grating system (404), in case the subscriber has no balance, the IN SCP provides a response (408). The MSC acting sends (409, 410) information pertaining to the subscriber via the proxy device (403) to the loan granting system. In case the loan granting system sends a signal representing loan rejection (411), the proxy device (403) seeks approval for sponsorship from the subscriber (412). In case the proxy device (403) receives consent (413) from the subscriber, the proxy device then sets the appropriate flags (414) at the routing device (406). Setting of the appropriate flags at the routing device acts as providing the routing information corresponding to the subscriber under consideration. The proxy device may also provide credit (415) to an account of the subscriber (maintained at IN SCP (402)). The proxy device also sets additional value added services (416) which are required to provide sub scriber specific additional information”.

Once the settings have been done in a manner as described above, some or all future communications involving the subscriber will then be routed by the routing device in accordance with the routing information as provided by the proxy device. In a preferred aspect the routing information can be such that the proxy device will be involved in the communication path and can thus exert control on the communication service. In one of the preferred modes, the proxy device exert control so as to provide one or more subscriber specific additional information to one or more of the initiating party or the terminating party.

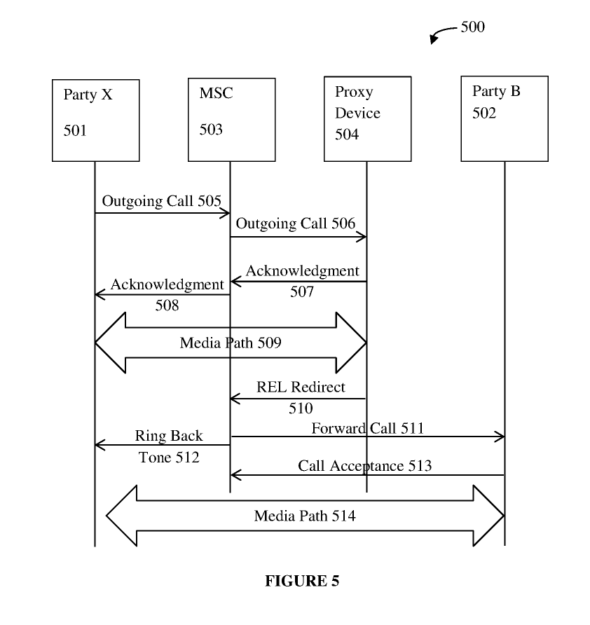

Considering a scenario of the communication service sought being a call (which can be either a voice call or a video call) and that the call is initiated by the loan non-eligible subscriber, FIG. 5 illustrates a call flow chart (500) for providing subscriber specific additional information to the loan non-eligible subscriber, when the loan non-eligible subscriber acts as an initiating party. In the flow chart there is illustrated Party X (who is the initiating party and who is the subscriber non-eligible for loan) (501) and Party B (502) (who is the terminating party). For the purposes of simplicity, the call flow chart shows only few elements of the telecommunication network and shows only a MSC (503) and the proxy device (504).

In the illustrated scenario, it is assumed that the configuration as mentioned with reference to FIG. 3 or 4 has been already performed and hence, the outgoing call initiated by Party X comes to the proxy device (505, 506). The proxy device after sending acknowledgement to Party X (507, 508) provides one or more subscriber specific additional information (509) to Party X. Considering the fact that the communication request is a call, special tone may be played to Party X on a media path which is established between Party X and the proxy device. Once the special tone has been completed, the MSC is directed (510) to forward the call to Party B. In accordance with the above, the MSC forwards the call to Party B (511) and sends a ring-back tone to Party X (512). Once the Party B accepts the call (513), a media path between Party X and party B is established (514).

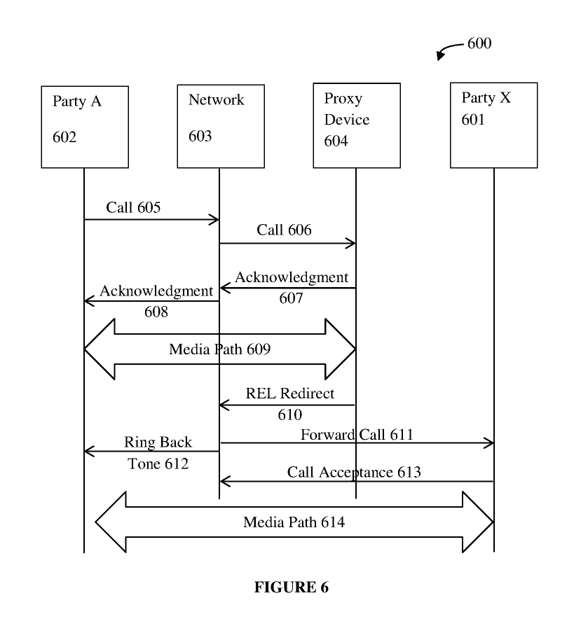

As indicated above, the method can also provide credit to the loan non-eligible subscriber in case any other subscriber (with whom the loan non-eligible subscriber is communicating) receives one or more subscriber specific additional information. This aspect is illustrated in FIG. 6 which shows a loan non-eligible subscriber as X (601) and the other subscriber as A (602). For the purposes of simplicity, one or more components of the telecommunication network which can be present for purposes of supporting the communication are shown by reference numeral 603 and the proxy device is shown by reference numeral 604.

In the illustrated scenario, it is assumed that the configuration as mentioned with reference to FIG. 3 or 4 has been already performed and hence, the call initiated by Party A comes to the proxy device (605, 606). The proxy device after sending acknowledgement to Party A (607, 608) provides one or more subscriber specific additional information (609) to Party A. Considering the fact that the communication request is a call, special tone may be played to Party A on a media path which is established between Party A and the proxy device. Once the special tone has been completed, the network is directed (610) to forward the call to Party X. In accordance with the above, the network forwards the call to Party X (611) and sends a ring-back tone to Party A (612). Once the Party X accepts the call (613), a media path between Party A and Party X is established (614). The credit which accrues to Party X for the action done by Party A (i.e. for receiving the one or more subscriber specific additional information) is credited to an account of party X.

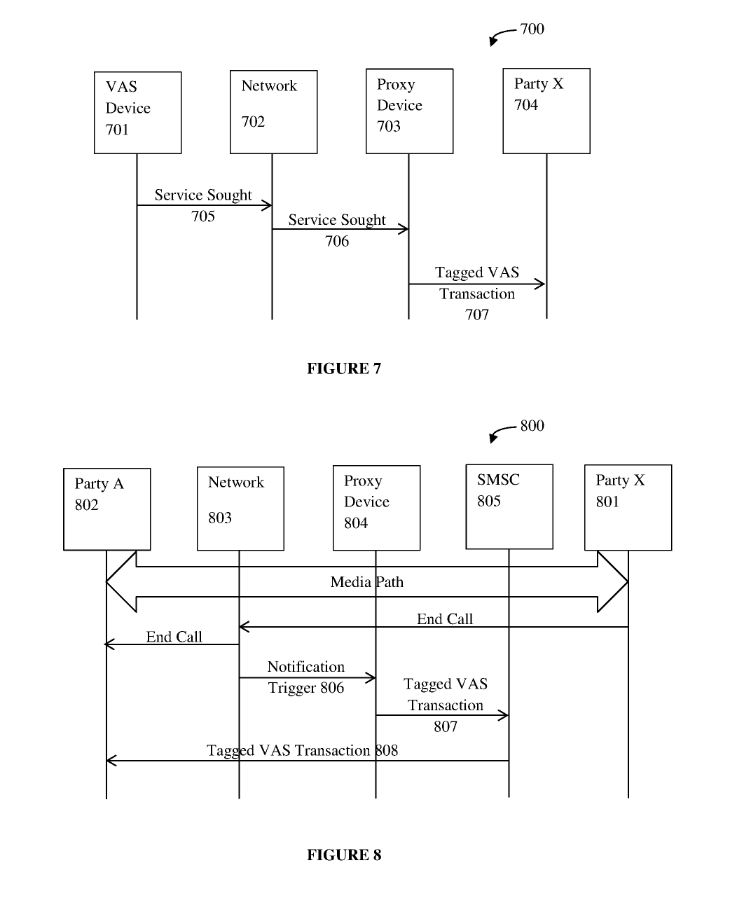

Referring now to FIG. 7, there is illustrated a call flow chart for a scenario wherein the communication service sought is delivered through a VAS device (701). In such a case, the VAS device (701) routes (705, 706) the communications service sought (which can be any one of message, data or even call) through telecommunication network (702) so as to be provided to the proxy device (703). The proxy device perform special message tagging to the VAS transaction to generate tagged VAS transaction and delivers (707) the tagged VAS transaction to Party X (704). The special message which is used for tagging represents the one or more subscriber specific additional information in this instance.

A tagged VAS transaction comprising one or more subscriber specific additional information can be generated and provided to any other subscriber (with whom the loan non-eligible subscriber is communicating) and the credit in respect of the same can be provided to the loan non-eligible subscriber. This aspect is illustrated in FIG. 8 which shows a loan non-eligible subscriber as Party X (801) and the other subscriber as Party A (802). For the purposes of simplicity, one or more components of the telecommunication network which can be present for purposes of supporting the communication are shown by reference numeral 803 and the proxy device is shown by reference numeral 804. Assuming delivery in the form of message of the tagged VAS transaction a SMSC (805) is further illustrated.

Once the communication between Party A and Party X comes to an end, a notification trigger is generated and provided to the proxy node by the telecommunication network (806). Based on the trigger, the proxy device generates a tagged VAS transaction comprising a special message. The special message which is used for tagging represents the Party A specific additional information in this instance. The tagged VAS transaction is then delivered to Party A via the SMSC (807, 808).

In all of the aforesaid scenarios, the proxy device also actively monitors an amount of subscriber specific additional information which is provided to the loan non-eligible subscriber and to other subscribers (who are communicating the loan non-eligible subscriber). Once a predetermined amount of subscriber specific additional information has been provided, the proxy device resets the routing information at the routing device. In other words, once the predetermined amount of subscriber specific additional information has been provided the routing information stored on the routing device with respect to the loan non-eligible subscriber will be modified such that the proxy device is not forming part of the communication path.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method for supporting communication service, said method comprising:
receiving, by a proxy device, a communication request originating from an initiating party and forwarding the communication request to a loan granting system;
receiving, by the proxy device, a signal indicative of loan refusal from the loan granting system;
informing the initiating party, by the proxy device, terms of sponsorship and seeking approval from the initiating party;
receiving, by the proxy device, a signal indicative of approval by the initiating party;
sending, by the proxy device, routing information to a routing device for storing in respect of the initiating party, the routing device acting upon the routing information while providing a communication service;
monitoring, by the proxy device, satisfaction of one or more predetermined conditions; and
sending, by the proxy device, instruction for deletion of the routing information from the routing device upon satisfaction of one or more predetermined conditions.

2. The method as claimed in claim 1, wherein the proxy device receives the communication request in case:
a. the initiating party has insufficient balance for the requested communication service; or
b. the communication request originating from the initiating party is preceded by special identifier.

3. The method as claimed in claim 1 further comprising: crediting predetermined amount of credit to an account maintained for the initiating party.

4. The method as claimed in claim 1 further comprising: provisioning one or more value added services for the user.

5. The method as claimed in claim 1 further comprising: receiving a communication service involving the initiating party and a terminating party in accordance with the routing information and providing one or more subscriber specific additional information to one or more of the initiating party or the terminating party.

6. The method as claimed in claim 5, wherein providing the subscriber specific additional information comprises intercepting a call and providing a special tone at a predetermined time.

7. The method as claimed in claim 6, wherein the special tone which is based on the profile of the initiating party or the terminating party.

8. The method as claimed in claim 5, wherein providing the subscriber specific additional information comprises intercepting a text message and inserting text based subscriber specific additional information in the text message.

9. The method as claimed in claim 1 further comprising: initiating a communication service to the initiating party and providing initiating party specific additional information.

10. The method as claimed in claim 1 further comprising: initiating a communication service with a terminating party as identified by the initiating party and providing terminating party specific additional information.

11. A device for supporting communication service, said device comprising:
a first receiving module for receiving a communication request originating from an initiating party;
a first transmitting module for forwarding the communication request to a loan granting system;
a second receiving module for receiving a signal indicative of loan refusal from the loan granting system;
a message generation module for informing the initiating party terms of sponsorship and seeking approval from the initiating party;
the first receiving module being further adapted to receiving a signal indicative of approval by the user;
a routing information generation module for generating and sending routing information to a routing device for storing in respect of the user, the routing device acting upon the routing information while providing the communication service; and
a module for monitoring satisfaction of said one or more predetermined conditions;
the routing information generation module being further configured to send instruction for deletion of the routing information from the routing device upon satisfaction of said one or more predetermined conditions.

12. A device as claimed in claim 11 further comprising:
a credit management module that deposits predetermined amount of credit to an account maintained for the initiating party.
